(19) United States
(12) Patent Application Publication
(10) Pub. No.: US 2018/0260839 A1
(43) Pub. Date: Sep. 13, 2018

(54) ITERATIVE DEDUCTION OF GRANULAR DATA SET BASED ON AVAILABLE AGGREGATIVE REPORTS

(71) Applicants: Yaniv NIZAN, Tel-Aviv (IL); Refael DAKAR, Tel Aviv (IL); Boris Spktr, Tel-Aviv (IL)

(72) Inventors: Yaniv NIZAN, Tel-Aviv (IL); Refael DAKAR, Tel Aviv (IL); Boris Spktr, Tel-Aviv (IL)

(21) Appl. No.: 15/920,432

(22) Filed: Mar. 13, 2018

Related U.S. Application Data
(60) Provisional application No. 62/470,626, filed on Mar. 13, 2017.

(51) Int. Cl. G06Q 30/02

(52) U.S. Cl. CPC G06Q 30/0242; G06Q 30/0247

(57) ABSTRACT

A method of associating ad revenue with users includes identifying actual revenue reported for a first user of a plurality of users, identifying first revenue, generated from an interaction, that cannot be associated with the first user due to a lack of ad interaction of the first user, identifying second revenue, generated from one or more interactions, that cannot be associated with users of the plurality of users other than the first user due to a lack of ad interaction of the users other than the first user and associating the second revenue with the first user, and repeating steps a, b, and c for additional users of the plurality of users.

This application claims the benefit of U.S. Provisional Application No. 62/470,626, filed Mar. 13, 2017, which is hereby incorporated by reference in its entirety.

### BACKGROUND

Today, to associate revenue with users companies either use estimations that can be very inaccurate or simply focus on low cost installs and hoping for the best. The existing solutions are collecting app opens, impressions or clicks and dividing the aggregated revenue by the count of app opens, impressions or clicks for associating ad revenue to the user that way. In other words these methods are using the average revenue per user (ARPU), the average revenue per impressions (eCPM) or the average revenue per click (eCPC) to associate revenue with users.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed embodiments may include one or more of the features described herein.

The invention is a method or algorithm that optimizes existing revenue reporting processes. The algorithm takes reports about revenue, clicks and impressions that are aggregated by country, day and sometimes additional dimensions like hours, placements, units or zones. It uses granular data about specific users that includes impressions and clicks but not revenue. The output of the method is the granular revenue per user that is far more accurate than what is produced by existing methods.

Inputs:

Aggregated table of impressions, clicks and revenue with no granular details

| | Clicks | Impressions | Revenue |
|---|---|---|---|
| User 1 | ? | ? | ? |
| User 2 | ? | ? | ? |
| Country: US | 524 | 7,402 | $8.34 |

Detailed reports about clicks and impressions but not revenue

| | Clicks | Impressions | Revenue |
|---|---|---|---|
| User 1 | 0 | 3 | ? |
| User 2 | 1 | 14 | ? |
| Country: US | 524 | 7,402 | $8.34 |

Output:

| | | | Minimal | Maximal |
|---|---|---|---|---|
| | Clicks | Impressions | Revenue | Revenue |
| User 1 | 0 | 3 | $0 | $0 |
| User 2 | 1 | 14 | $0.91 | $0.94 |
| Country: US | 524 | 7,402 | $8.34 | $8.34 |

Existing models mainly rely on averages to estimate revenue so their output is only an estimate with a wide error margin. This method, however, is a deterministic one and outputs a minimal and a maximal number for each user in addition to the estimated revenue. The model is built in a way that guarantees the revenue will be no less than the minimum and not more than the maximum. This limits the error margins and make it a lot more practical when compared to prior art.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a flowchart diagram of a method according to an embodiment of the present invention

FIG. 2 is an illustration of an example situation.

FIG. 3 is an illustration of a method of attributing revenue by dividing revenue by number of users.

FIG. 4 is an illustration of a method of attributing revenue by dividing revenue by number of impressions.

FIG. 5 is an illustration of a step of eliminating users with no impressions.

FIG. 6 is an illustration of a step of using known sources to limit revenue.

FIG. 7 is an illustration of a step of associating revenue using impressions coming from CPI campaigns.

FIG. 8 is an illustration of a step of combining the steps of FIGS. 6 and 7.

FIG. 9 is an illustration of a step of associating revenue using impressions coming from CPC campaigns.

FIG. 10 is an illustration of a step of breaking down revenue based on quarters of the day.

FIG. 11 is an illustration of a step of combining the steps of FIGS. 6-10.

FIG. 12 is an illustration of a general case step associating revenue by narrowing down, elimination and elimination of revenue from the rest of the users.

FIG. 13 is an illustration of a step of outputting an outcome.

### DETAILED DESCRIPTION

Iterative deduction of granular data set based on available aggregative reports will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted.

The description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

The invention is a method or an algorithm. It is carried out using computer software.

The invention is optimizing existing methods for estimating granular data about revenue that originates from ad based monetization. This optimization is essential for companies in order to perform the following tasks with sufficient accuracy:

Measure their returns on each marketing activity also known as ROAS (return on ad spend)

Optimize their revenue by iterating and comparing revenues between different versions and testing groups

Enhance revenue by segmenting and personalizing parts of their applications based on understanding which users are generating revenue through advertising.

The prior art referred to in this document is estimating granular ad revenue by leveraging the averages revenue per user in each country or by leveraging the average revenue per impression in each country. This means:

All marketing activities will appear as yielding the same amounts of revenues per user

All versions of the application will appear as generating the same amounts of revenue per user

All segments will appear as generating the same amounts of revenue per user

For example: let's assume that the app owner wants to compare 2 variations of the application to determine which one is better as part of an optimization process. He implements an A/B test also known as split test so users in group A sees one version and users in group B see the other version. Each group has 1,000,000 users residing in United States. And the average revenue per user in US is $0.2 per month. Here is the output:

| | Users | Monthly revenue |
|---|---|---|
| Group A | 1,000,000 | $200,000 |
| Group B | 1,000,000 | $200,000 |

This clearly shows how using an estimation method that is based on average doesn't produce results that are good enough for the purpose of optimization through A/B testing.

Our method is an optimization of that method. It uses logical segmentation and logical deduction to determine a smaller range of the potential revenue. It uses the average method only after the potential minimum and the potential maximum are close to each other.

The invention is currently used to breakdown revenues in advertising for ads that appear in mobile apps. It can be implemented for mobile web applications, web applications and possibly to other fields.

Our algorithm optimizes this process by using an iterative process.

| | Minimal | Maximal | Output | Potential |
|---|---|---|---|---|
| | Revenue | Revenue | Revenue | error level |
| Prior Art | 0 | T | T/U | Error could |
| | | (Where T = | (Where U = | be as high as |
| | | total | total number | T − T/U and |
| | | aggregated | of users) | where U is |
| | | revenue | Or T * SI/TI | large enough |
| | | for all | (Where SI = | T − T/U is |
| | | users) | number of | approximately |
| | | | impressions | T. |
| | | | by this user | |
| | | | and TI = total | |
| | | | number of | |
| | | | impressions) | |
| Optimization - | A1 | B1 | (B1 − | The maximal |
| step 1 | (Where A1 | (Where B1 | A1) * SLI1/TLI1 | error will |
| | is the | is the | (Where SLI1 | always be |
| | logically | logically | is the number | less than. |
| | determined | determined | of specific | B1 − A1 |
| | possible | possible | impression | Which is ≤ T − 0 |
| | Minimum | Maximum | left | |
| | and A1 ≥ | and A1 ≤ | unassociated | |
| | 0) | T) | for that user | |
| | | | and TLI1 is | |
| | | | the number of | |
| | | | unassociated | |
| | | | impressions | |
| | | | left for all | |
| | | | users) | |
| Optimization - | A2 | B2 | (B2 − | B2 − A2 |
| step 2 | (Where A2 ≥ | (Where B2 ≤ | A2) * SLI2/TLI2 | Which is ≤ |
| | A1) | B1) | | B1 − A1 |
| Optimization - | An | Bn | (Bn − | 0.05 * R |
| step n | | | An) * SLIn/TLIn | (Where R is |
| | | | | the real |
| | | | | revenue for |
| | | | | that user) |
| | | | | The algorithm |
| | | | | stops only |
| | | | | when (Bn − An) |
| | | | | is <0.05 * Bn |
| | | | | and |
| | | | | An ≤ R ≤ Bn |

Step 0—the minimum is set the $0 and the maximum is set for the aggregated amount reported for all the users in the group.

Step n—the algorithm breaks down the aggregated report to at least 2 part using a reporting dimension. It looks for one of 3 things:
Indication of actual revenue reported for that user
Indication allowing the eliminate the possibility of revenue generated from a certain impression for a certain user usually through lack of ad-interaction (clicks or conversions) in campaigns that pay only when such interaction occurs.
Indication allowing to eliminate revenue for all the other users (again through lack of ad-interactions or other signals) and giving all the revenue to the user in hand.

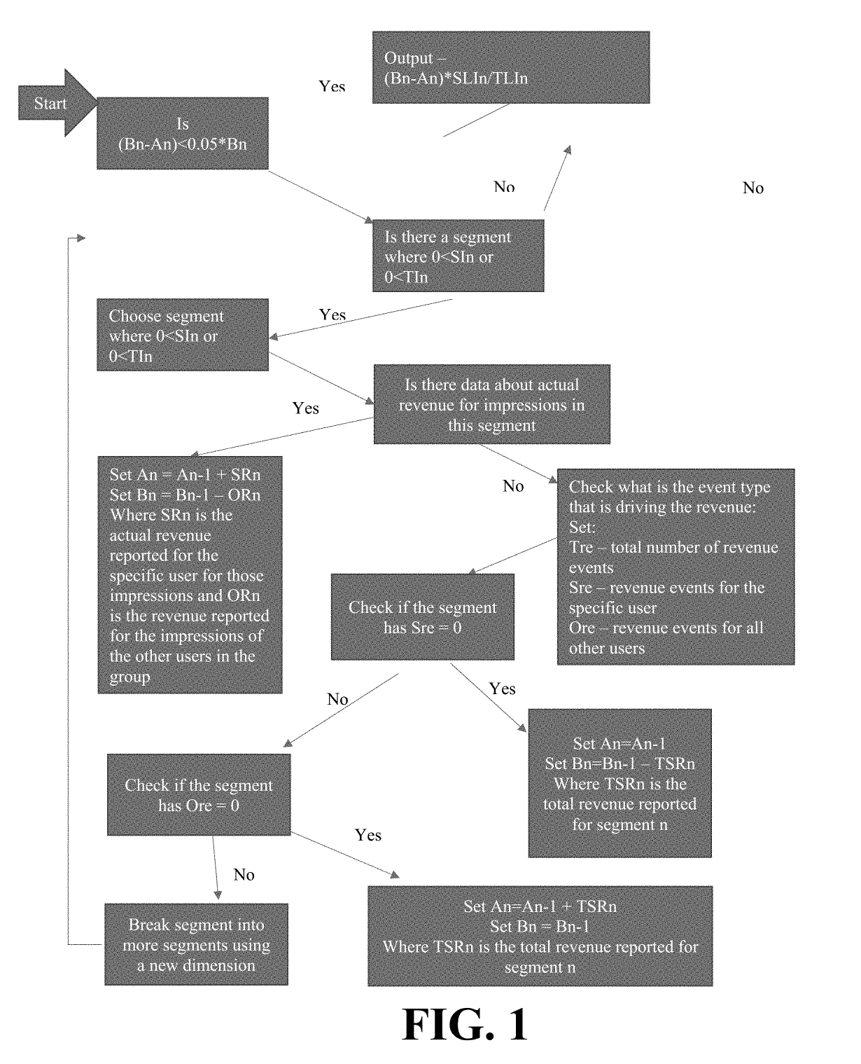

As illustrated in FIG. 1. Each one of these things when occurs, helps move either the minimum or the maximum thresholds towards each other.

### Example

Let's consider the following example:

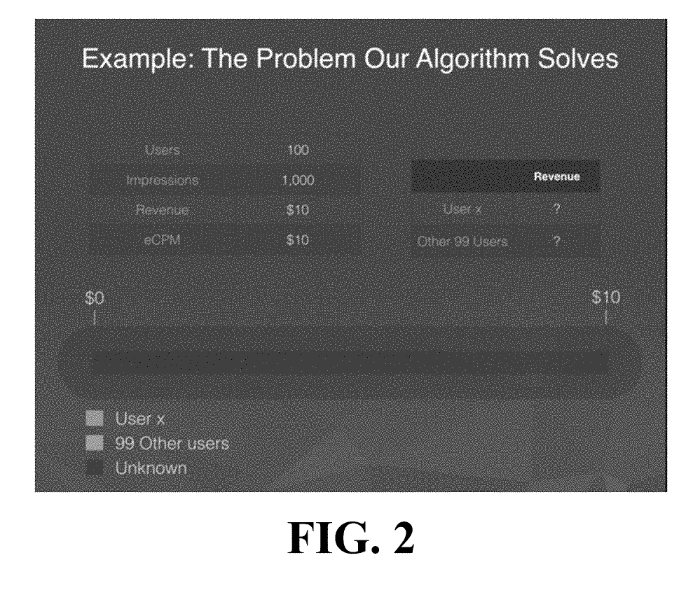

As illustrated in FIG. 2, there are 100 users generating $10 through 1,000 impressions. We want to know the breakdown of the revenue for user x (that could be any user) and the rest of the 99 users. In this example, there is a chart for each step that represents what we already know about the revenue breakdown vs. what we don't know.

First, let's see what alternative solutions are doing:

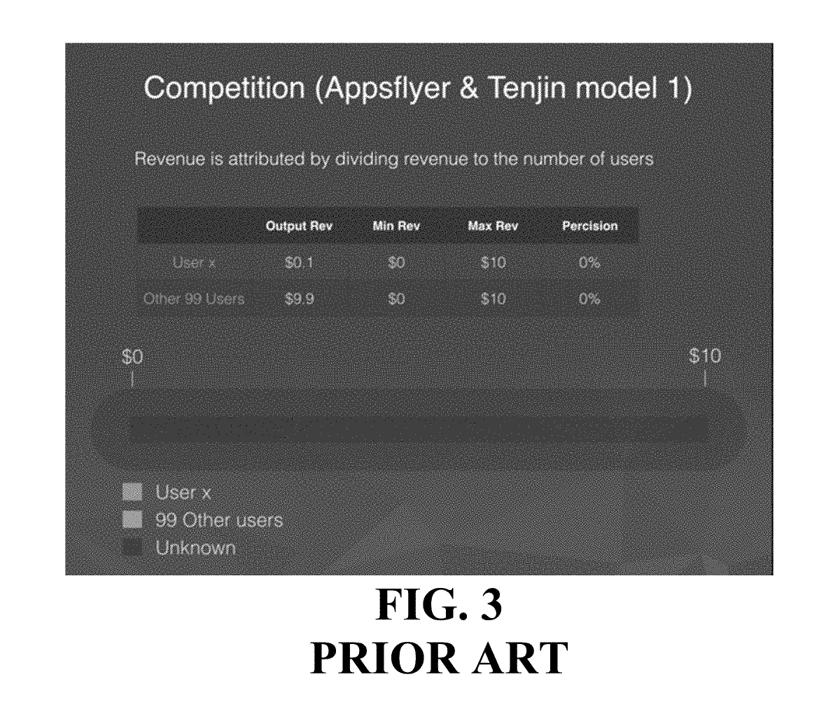

Dividing the revenue evenly (FIG. 3) or according to the number of impressions

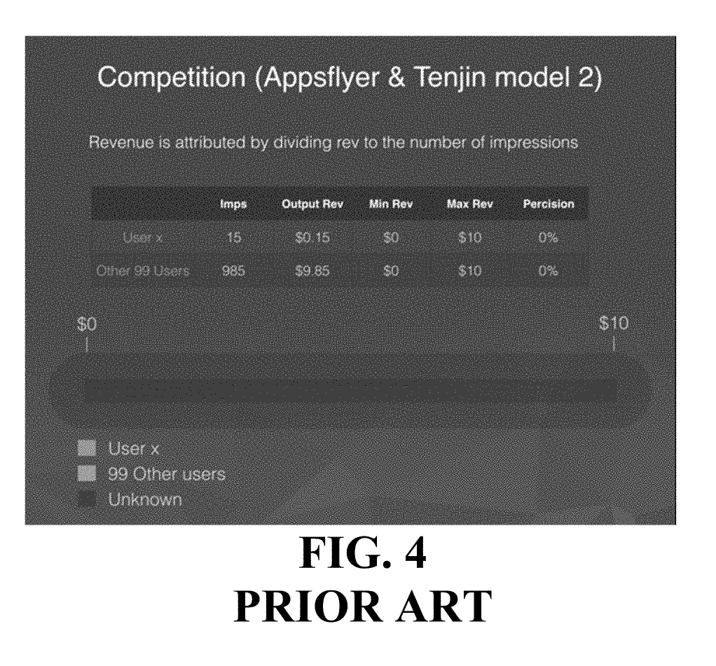

(FIG. 4) yields an output but really doesn't get us any closer to knowing the true revenue of user x.

How our algorithm operates in this example:

Step 1

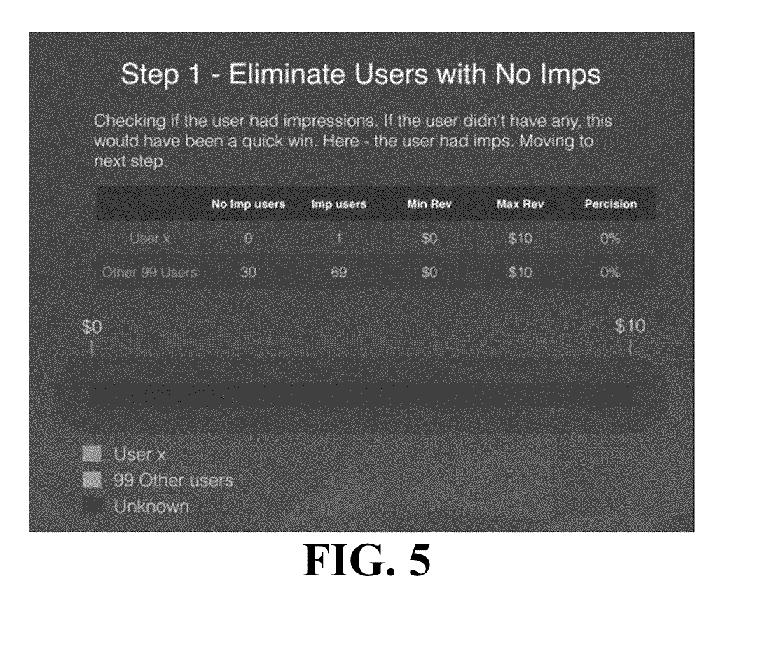

First, as illustrated in FIG. 5, we look at the entire plane and check if we can eliminate all revenue for user x. We check if he even had impressions. Since, user x had impressions, we can't eliminate the possibility of revenue for the entire plane. In some of the steps, the algorithm doesn't make any apparent process. This step was a long shot and didn't yield any progress.

Step 2

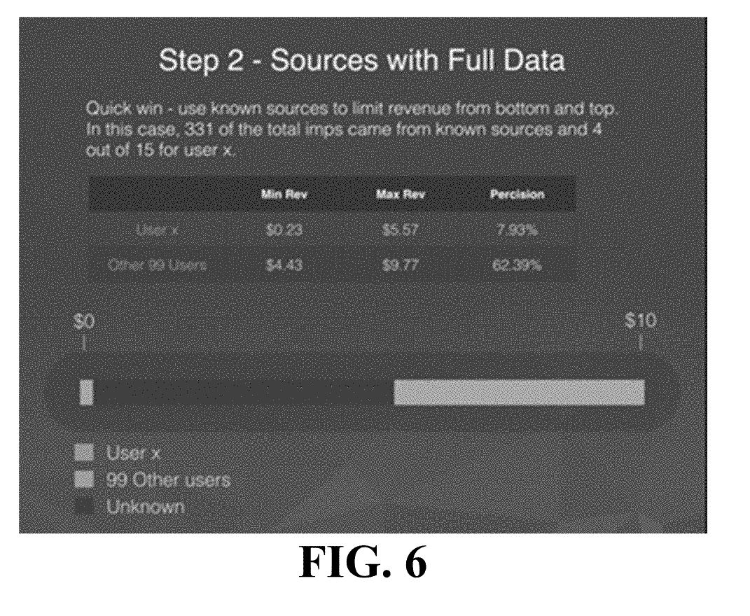

Here, as illustrated in FIG. 6, we are breaking the plane into 2. We are looking only at sources where we can get full data about granular users. In these cases, we can get that 331 impressions with an aggregated revenue of $4.66. The breakdown allows us to associate $0.23 of the revenue with user x but also reduce the maximal revenue significantly since we associated $4.43 with the other users.

Step 3

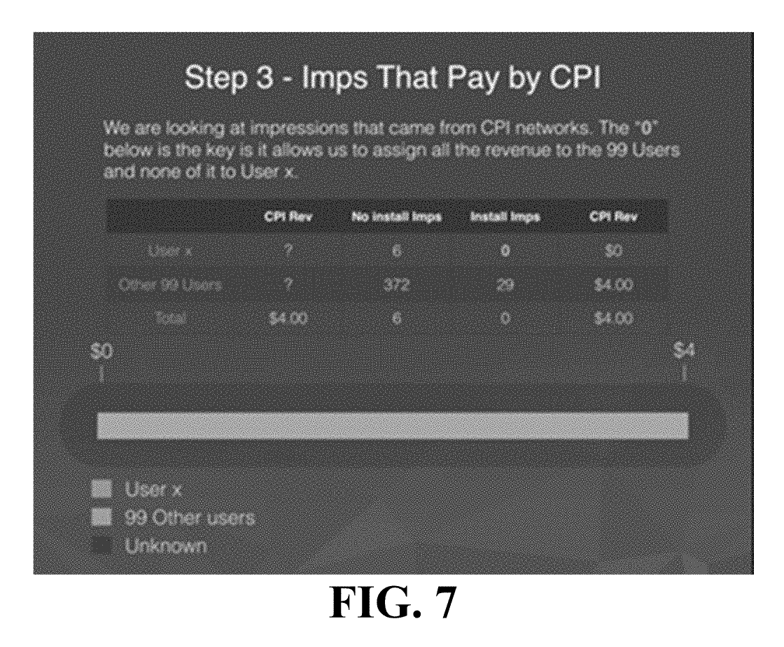

Here, as illustrated in FIG. 7, we are looking only at impressions that came through CPI campaigns. This means they only pay if an install occurred after the impression. There are 378 from such campaigns and together they amounted to $4 in revenues. In this breakdown, we see that out of the 6 impressions generated by user x, none resulted in installs so we can eliminate the possibility of revenue for user x. Thus, all the revenue can be associated with the other users.

Step 3a

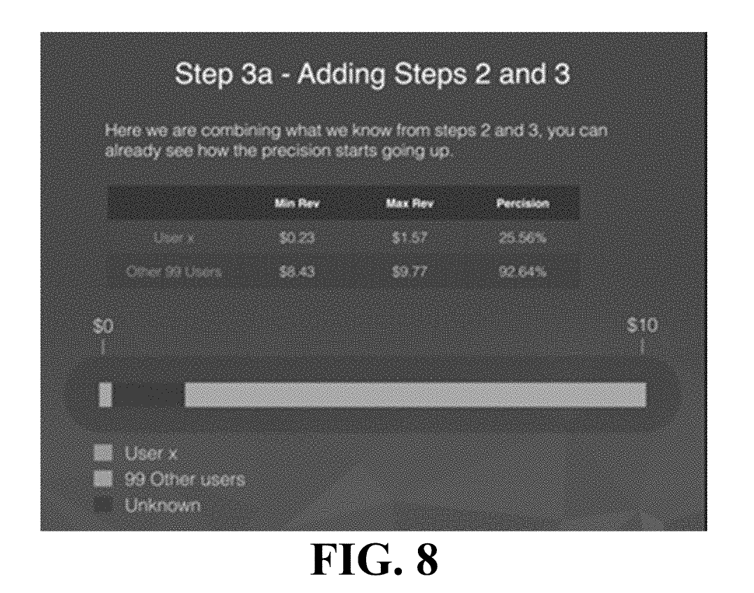

Here, as illustrated in FIG. 8, we are combining what we already know. We can see that associating $4 with the 99 other users limited the maximal revenue for user x to $1.57.

Step 4

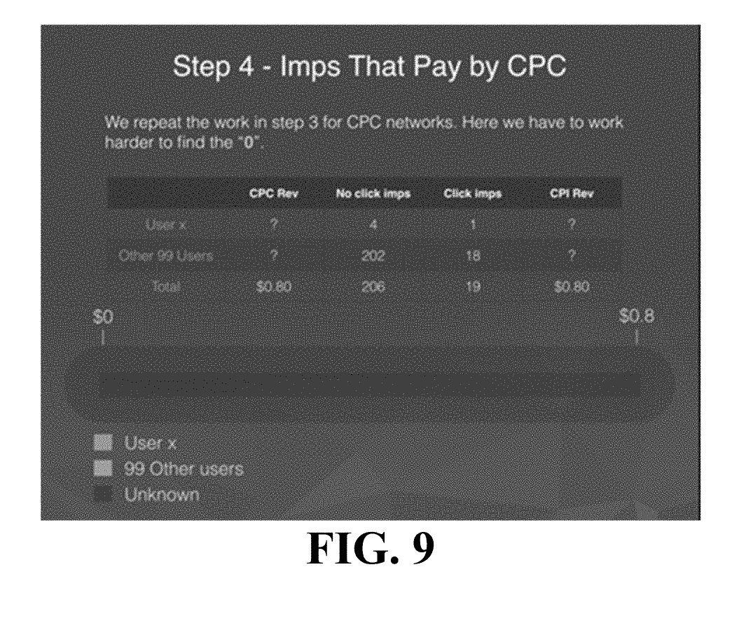

We are now looking at CPC campaigns that pay only when the user clicks, as illustrated in FIG. 9. There were 206 impressions from such campaigns and they resulted in $0.8 in revenues. Since user x has 1 click, we can't eliminate the possibility of revenue. Therefore, we break the plane using the time dimension to 4 parts as presented in step 4a.

Step 4a

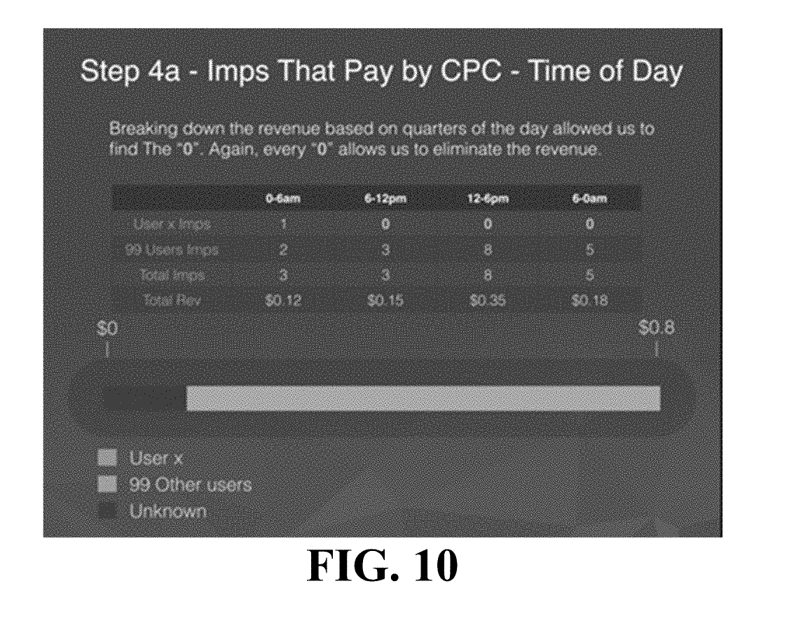

Here, as illustrated in FIG. 10, we can eliminate the possibility of revenue for three quarters of the day since user x only had a click in the first quarter. When we look at how the revenue is broken down into quarters we see that $0.12 was created in the first quarter and $0.68 can be associated with the other 99 users.

Step 4b

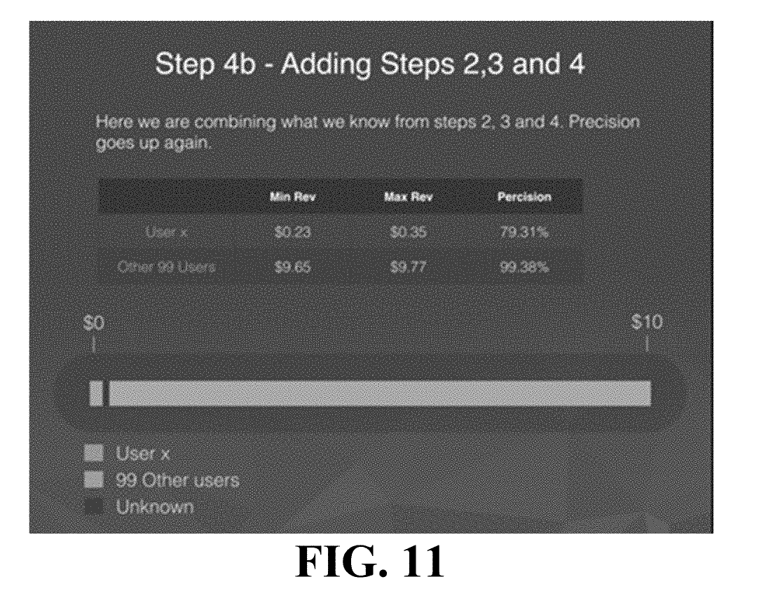

Here, as illustrated in FIG. 11, we are combining all the steps up to here.

Associating $0.68 with the other 99 users reduced the maximum for user x to $0.35. The min to max range is now $0.12 which is about 83 times smaller compared to alternative methods.

Step n—The General Step

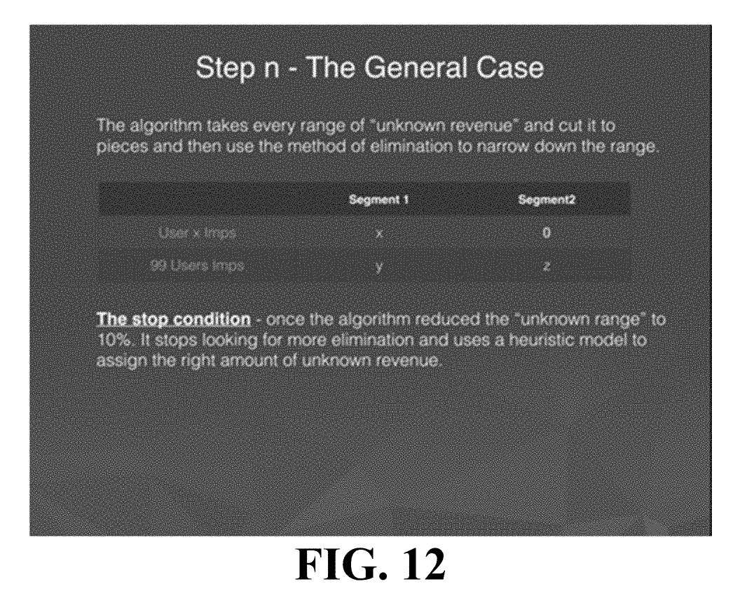

As described before, and as illustrated in FIG. 12, the general case is associating revenue in one of 3 methods. Narrowing down, elimination and elimination of revenue from the rest of the users.

Final Step

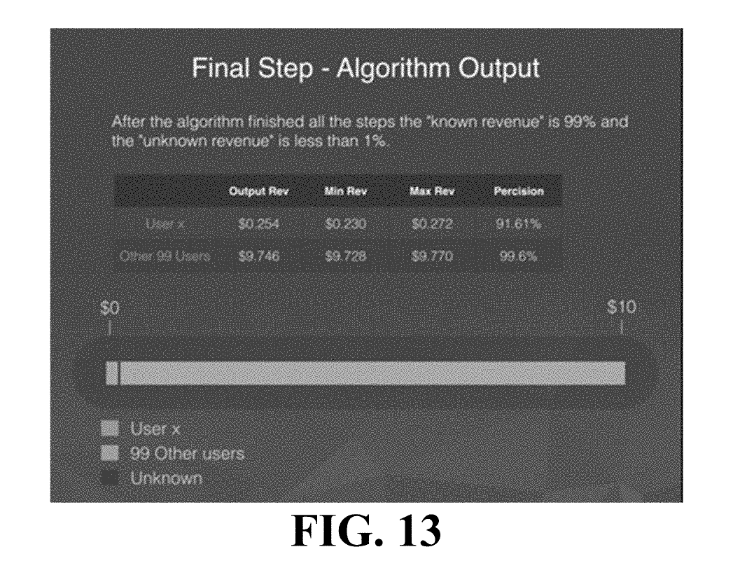

Continuing the process would have resulted in the following outcome, as illustrated in FIG. 13. The min to max range becomes $0.042, about 240 times smaller compared to the alternatives.

The invention works better if we add more dimensions that allow us to break the plane into smaller pieces. The more we can do that, the more precise the result will become.

It's also possible that this invention can be used for the application of bond trading. Wall Street firms have been inventing complex securities that are sometimes made of mixes of other securities. CDO stands for collateralized debt obligation an is such a security that is comprised out of many consumer loans. Often the details of such loans are not available but there is aggregative information available about the CDO.

The invention is not limited to the particular embodiments illustrated in the drawings and described above in detail. Those skilled in the art will recognize that other arrangements could be devised. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application While the invention has been described with reference to specific illustrative embodiments, modifications and variations of the invention may be constructed without departing from the spirit and scope of the invention as set forth in the following claims.

I claim:

1. A method of associating ad revenue with users, comprising:
a) identifying actual revenue reported for a first user of a plurality of users;
b) identifying first revenue, generated from an interaction, that cannot be associated with the first user due to a lack of ad interaction of the first user;
c) identifying second revenue, generated from one or more interactions, that cannot be associated with users of the plurality of users other than the first user due to a lack of ad interaction of the users other than the first user and associating the second revenue with the first user; and
repeating steps a, b, and c for additional users of the plurality of users.
